(19) United States
(12) Patent Application Publication
(10) Pub. No.: US 2011/0315414 A1
(43) Pub. Date: Dec. 29, 2011

(54) Screwdriver and control method

(75) Inventors: Jochen Kuntner, Dornbirn (AT); Peer Schmidt, St. Gallen (CH)

(73) Assignee: Hilti Aktiengesellschaft, Schaan (LI)

(21) Appl. No.: 13/134,883

(22) Filed: Jun. 20, 2011

(30) Foreign Application Priority Data
Jun. 23, 2010 (DE) 10 2010 030 410.7

(51) Int. Cl. B25B 21/00; B25B 23/00

(52) U.S. Cl. 173/1; 173/2

(57) ABSTRACT

A control method for a screw including the following steps: a spindle (14) is driven by a motor (11) in order to turn a screw (19) around an axis of rotation (15). A magnetic field is generated around the turning screw (19). A modulation of the magnetic field caused by the turning screw (19) is detected by an active magnetic-field sensor (38). A switch-off criterion is selected by a screw-recognition device (28) on the basis of the detected modulation. The turning of the screw (19) is stopped by a switch-off device (24) as soon as the switch-off criterion is met.

This claims the benefit of German Patent Application DE 10 2010 030 410.7, filed Jun. 23, 2010 and hereby incorporated by reference herein.

The present invention relates to a screwdriver and to a control method for a screwdriver.

### BACKGROUND

In the construction sector, screws are employed, among other things, to fasten metal sheets. For this purpose, screws with a drilling tip have been developed that drill a hole into the metal sheet before the thread of the screw and subsequently the head of the screw fasten the metal sheet to a substrate. The user attempts to end the screwing procedure when the screw head comes into contact with the metal sheet. In doing so, the user is assisted by a slip clutch that interrupts the force transmission beyond a triggering torque that has to be set correctly. The user has to ensure that the correct triggering torque is set for each type of screw used.

### SUMMARY OF THE INVENTION

An object of the present invention is to simplify the operation.

The present invention provides a screwdriver having a motor and a spindle that is coupled to the motor in order to turn a screw around the axis of rotation. An adjustable switch-off device serves to switch off the rotational movement of the spindle. An active magnetic-field sensor is arranged in such a way that a modulation—caused by the turning screw—of a magnetic field generated by the active magnetic-field sensor can be detected by the magnetic-field sensor. A screw-recognition device is installed between the active magnetic-field sensor and the adjustable switch-off device in order to set a switch-off criterion for the switch-off device based on the modulation detected by the active magnetic-field sensor.

The inventive control method for a screwdriver comprises the following steps. A spindle is driven by a motor in order to turn a screw around an axis of rotation. A magnetic field is generated around the turning screw and a modulation of the magnetic field caused by the turning screw is detected by an active magnetic-field sensor. The switch-off criterion is selected by a screw-recognition device on the basis of the detected modulation. The turning of the screw is stopped as soon as the switch-off criterion is met.

The active magnetic-field sensor generates its own magnetic field. The screws are distinguished from each other on the basis of their passive influence on the magnetic field.

A special feature of the device and of the method is that a screw can be recognized or switch-off criteria can be determined while the screw is being turned. Therefore, the recognition can be carried out while the screw is being put in place. The switch-off device can thus be individually set for each screw that is about to be placed.

A sensor element of the active magnetic-field sensor that is sensitive to magnetic fields can be arranged in such a manner that the inductive sensor element overlaps with the head of a screw in the direction of the axis of rotation. The inductive sensor element should preferably detect impressions on an underside of the screw. The sensor element that is sensitive to magnetic fields can be, for instance, an inductive sensor element in which a current is generated as a function of the magnetic field. The sensor element that is sensitive to magnetic fields can have an electromagnetic oscillating circuit whose resonance frequency or whose attenuation is influenced by the measured magnetic field. Another variant makes use of a Hall sensor as the sensor element.

One embodiment provides that the active magnetic-field sensor has an electromagnet that is arranged on the tool end of the spindle.

One embodiment provides that the switch-off device is electrically coupled to the motor in order to switch off the motor. The switch-off device deactivates the motor when the switch-off criterion is met.

One embodiment of the invention provides that an electrically actuatable clutch is installed in a force path between the motor and the spindle, and the switch-off device is electrically connected to the clutch in order to operate the clutch. The switch-off device transmits a control signal to release the clutch located between the motor and the spindle when the switch-off criterion for switching off the turning of the screw is met.

In one embodiment, a monitoring sensor is provided with which a signal can be detected that serves as the measure for the distance of the spindle to a workpiece and/or a signal as the measure for a torque that is transmitted to the spindle. The switch-off device is coupled to the monitoring sensor in order to compare the signal to the switch-off criterion. The turning of the screw should be stopped once it has been screwed deep enough into the workpiece, that is to say, when the distance between the tool and the workpiece has fallen below a threshold value specified by the switch-off criterion. As an alternative or in addition thereto, the procedure is switched off when a rising torque indicates that the screw head is touching the workpiece.

One embodiment provides that the screw-recognition device has a frequency analyzer to determine a spectrum of the modulation. A frequency spectrum of the modulation is ascertained and the switch-off criterion is selected on the basis of the frequency spectrum. Even though the determination of the frequency spectrum requires the screw to be turned several times and thus takes time, in exchange, the evaluation of the spectrum has proven to be less susceptible to malfunctions than an evaluation of the modulation within the time range.

One embodiment provides that the screw-recognition device has a memory unit which stores parameterized modulations as well as stored switch-off criteria associated with these parameterized modulations. The screw-recognition device has a search device to select the switch-off criteria that are associated with a parameterized modulation and that correspond to a modulation detected by the active magnetic-field sensor. The search device is coupled to the switch-off device so that the latter can be set with the ascertained switch-off criteria.

### BRIEF DESCRIPTION OF THE DRAWINGS

The description that follows explains the invention on the basis of embodiments and figures provided by way of examples. The figures show the following:

FIG. 1 an electric screwdriver;

FIG. 2 a longitudinal section through a screw;

FIG. 3 a bottom view of the screw;

FIG. 4 a signal curve of a magnetic-field sensor with the screw from FIG. 3;

FIG. 5 a spectrum belonging to the signal curve from FIG. 4.

### DETAILED DESCRIPTION

Unless otherwise indicated, the same or functionally equivalent elements are designated by the same reference numerals in the figures.

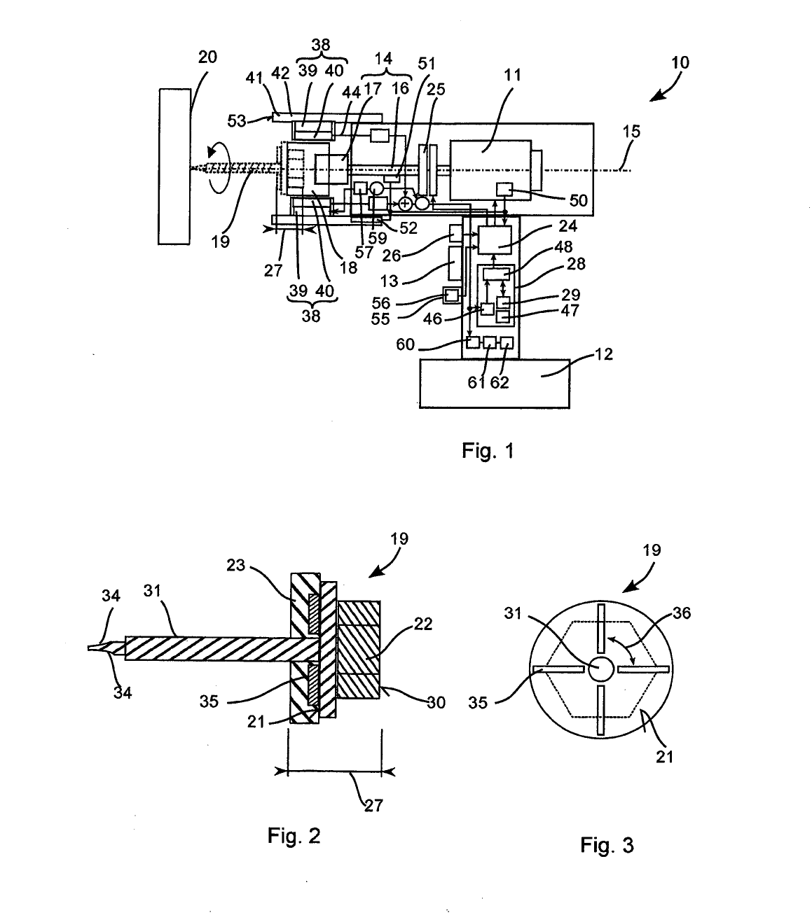

FIG. 1 shows a hand-held, motor-driven screwdriver 10 by way of an example. The screwdriver 10 has a motor which is powered, for example, by an electric battery 12. When a user actuates a button 13, the motor 11 is activated in response. The motor 11 drives a spindle 14 around an axis of rotation 15. The spindle 14 has a drive shaft 16 whose tool end has a tool-receiving socket 17 and/or an integrated tool. A tool 18, for instance, a socket or a screwdriver bit, can be detachably inserted into the tool-receiving socket 17. The integrated tool can be, for example, a socket to receive a standardized hex screw head. A user manually inserts a screw 19 into the tool-receiving socket 17 or into the integrated tool. When the spindle 14 turns, the screw 19 likewise turns around the axis of rotation 15. The screw 19 can be placed onto one of the tools either automatically or semi-automatically by means of a cartridge attachment.

The screwdriver 10 has an auxiliary device that allows screws 19 to be screwed into a workpiece 20 automatically. After the screw 19 has been screwed in, the underside 21 of its screw head 22 is supposed to rest against the workpiece 20. Optionally, a washer 23, for example, in the form of a gasket made of silicon, is arranged between the underside 21 and the workpiece 20. The pressure exerted by the screw head 22 onto the workpiece 20 is moderate in order to avoid damaging strains in the screw 19. Moreover, if present, the washer 23 should only be held in place and not be crushed.

The auxiliary device is based on a switch-off device 24 that switches off the driven rotational movement of the spindle 14. For instance, the motor 11 can be switched off for this purpose. As an alternative, between the motor 11 and the spindle 14, there is a clutch 25 that can be released by the switch-off device 24 in order to interrupt the torque transmission for purposes of switching off the rotational movement of the spindle 14. The clutch 25 can be, for example, a magnetic clutch that can be actuated by a control signal of the switch-off device 24. The clutch 25 can also be another type of disengageable clutch such as, for instance, an electromagnetic wrap-spring clutch.

The recognition of the point in time for the switch-off device 24 to switch off the screwdriver can be based on at least one of the two following variants: (a) the screwdriver 10 checks the placement depth of the screw 19 as the switch-off criterion and switches off the further turning of the spindle 14 as soon as the placement depth has reached a prescribed value; (b) the screwdriver 10 monitors the torque generated by the spindle 14 as the switch-off criterion and ends the further turning once the torque has a characteristic signature for the placed screw 19. The characteristic signature can be the exceeding of a threshold value by the current torque or an exceeding of the threshold value due to the rate of increase of the torque.

The screwdriver 10 can have a setting or operating device 26 that allow the user to set the switch-off device 24 for a screw 19. These properties can be, among others, the height 27 of the screw head 22, optionally including the height of the washer 23 for the placement depth, a maximally permissible torque for the torque monitoring, etc. The switch-off device 24 converts the entered variables into the corresponding switch-off criteria.

A screw-recognition device 28 assists the user in setting the switch-off criteria for the auxiliary device. The screw-recognition device 28 recognizes the type of a screw 19 being turned by the screwdriver 10. The switch-off criteria pertaining a given type of screw for the switch-off device 24 are stored in a memory unit 29 of the screw-recognition device 28. As soon as the screw-recognition device 28 has determined a screw type, the switch-off criterion associated with that screw type is selected from the memory unit 29 and the switch-off device 24 is set in accordance with the selected switch-off criterion. The switch-off criteria can be set fully automatically without any interaction with the user. As an alternative, before the switch-off criterion is set, the user is prompted to make a confirmation before the criterion is accepted by the switch-off device 24.

Before a screw-recognition device 28 is explained in greater detail by way of an example, especially suitable screws 19 will be described. In many areas of application, the top of the head 22 of a screw 19 that has been placed remains visible. Consequently, for a number of reasons, visible recognition features on the top 30 of the screw 19 are not desirable.

FIG. 2 shows a longitudinal section through the structure of a cutting screw 19 presented by way of an example. FIG. 3 shows the screw 19 in a view from below. The screw 19 has a screw head 22, a thread 31 and a tip 32 along an axis 33. The tip 32 has one or two cutting edges 34 to drill into a metallic workpiece, for instance, a steel sheet. The cutting edges 34 can cut into and remove the metal, or else they can deform it in order to create a hole for the thread 31. The optional washer 23 made of an elastic plastic such as, for instance, silicon, can rest against the underside 21 of the screw head 22. The washer 23 can serve as a sealing element in order to seal the hole water-tight.

Four largely identical ribs 35 that run radially and extend in the axial direction are provided on the underside 21 of the screw head 22. Each of the ribs 35 is arranged at an angle 36 of 90° relative to its adjacent ribs 35. Consequently, the underside 21 or the arrangement of the ribs 35 has a rotational symmetry of order 4 around an axis of rotation 37 of the screw 19. The underside 21 has a rotational symmetry of order n when the underside comes to coincide with itself after being turned by an angle of 360/n degrees, in the example a rotational symmetry of order 4 at 90°.

The ribs 35 are preferably made of the same material as the screw head 22, for example, iron, steel or another hard-magnetic or soft-magnetic material. The ribs 35 can be made, for instance, by embossing the underside 21 of the screw head 22. The number and shape of the ribs 35 serves as a code for a screw type. The screw 19 shown does not constitute a limitation for the screw-recognition device 28. In particular, depressions can be embossed instead of the projecting ribs 35. The embossed structures can also be arranged exclusively in the vicinity of the circumference of the screw head 22.

The screw-recognition device 28 is based on the inductive detection of the ribs 35 by means of an active magnetic-field sensor 38.

The magnetic-field generator 39 of the magnetic-field sensor 38 generates a magnet field that surrounds the screw 19. The magnetic-field generator 39 is preferably arranged at the height of the screw head 22 and can be arranged preferably at a lateral distance from the axis of rotation 15. In an alternative embodiment, the magnetic-field generator 39 surrounds the axis of rotation 15 in a ring-shaped manner. The magnetic-field generator 39 can be, for instance, a permanent magnet or an electromagnet, that is to say, a coil through which current passes.

Due to their magnetic properties, the screw 19 and its ribs 35 influence the course of the magnet field lines and thus the local magnetic field intensities. An inductive sensor element 41 is preferably arranged in the direction of the axis of rotation 15 at the height of the screw head 22. As seen along the axis of rotation 15, the inductive sensor element 40 and the screw head 22 overlap. The length of the screwdriver bit or other tools is largely standardized, so that at least the position of the top 30 of the screw head 22 along the axis of rotation is known. The inductive sensor element 40 can be integrated, for example, into a sleeve 41 of the depth stop 42. The inductive sensor element 40 is preferably arranged at a radial distance from the axis of rotation 15 and structured so as to be non-symmetrical to the axis of rotation 15. An axis of the ring-shaped sensor element 40 is arranged so as to be offset with respect to the axis of rotation 15. The sensor element 40 which is, for instance, inductive, can be in the form of, for instance, a Hall sensor, a pick-up coil. The embodiment presented employs several inductive sensor elements 40.

The sensor element 40 is electrically interconnected, for example, with a Wheatstone bridge in a differential measurement. A first sensor element 40 is interconnected between a pick-up and a feed point, while an identical, second sensor element 40 is interconnected between another pick-up and the other feed point. An identical sensor element, which is shielded against magnetic fields, can also be interconnected in the two additional bridges.

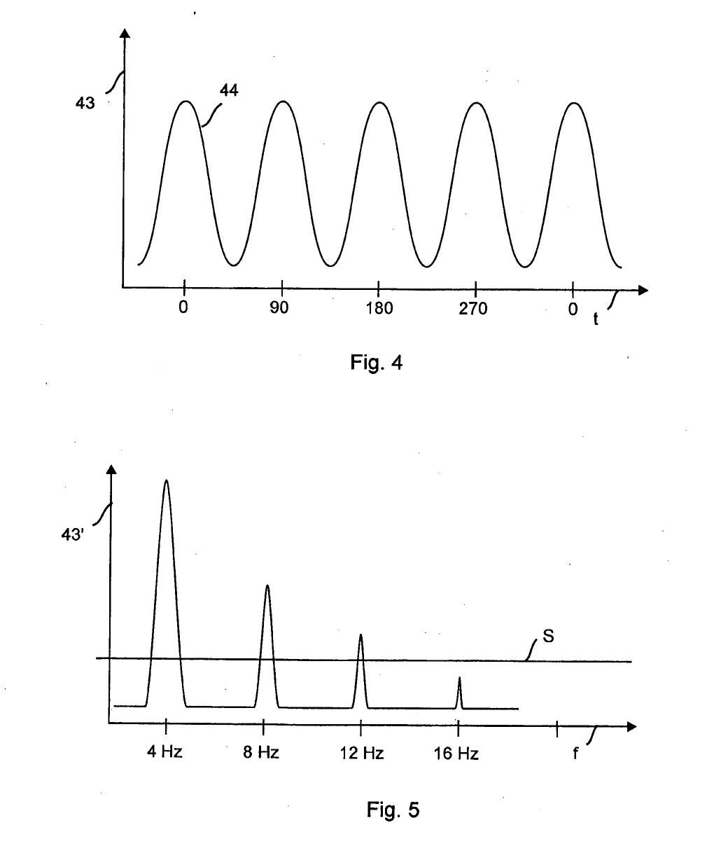

When the button 13 is actuated, the screw-recognition device 28 and the active magnetic-field sensor 38 are activated, insofar as they were not already active. The motor 11 turns the spindle 14 along with the screw 19 around the axis of rotation 15. The ribs 35 move closer together and further apart due to the rotational movement of the inductive sensor element 40. Owing to their magnetic properties, the ribs 35 influence the course of the magnetic field and thus the intensity of the magnetic field in the area of the inductive sensor element 40. FIG. 4 schematically shows an amplitude 43 of a signal 44 that is provided by way of an example and that is a measure of the magnetic-field strength in one of the inductive sensor elements 40. The amplitude 43 reaches an extreme value when one of the ribs 35 is at the smallest distance from the inductive sensor element 40. Due to the four identically configured ribs 35 arranged at equidistant angles 36, the signal 44 is periodically repeated over the course of time t. The position of the maxima is indicated in terms of having been converted into the angular position of the spindle 14. On the basis of the signal 44, a frequency analyzer 46 of the screw-recognition device 28 ascertains a frequency spectrum or the actual fraction of the frequency spectrum without phase information. The frequency spectrum of the signal 44 shows a value (peak) at a basic frequency f that corresponds to four times the rotational speed of the spindle 14 (FIG. 5). The physical width of the ribs 35 yield values at the harmonics of the basic frequency f. The ratio of the basic frequency f to the rotational speed is determined by the number of regularly arranged ribs 35. The relative amplitudes 43′ of the spectrum at the basic frequency and the harmonics are determined, among other things, by the shape of the ribs 35.

The screw-recognition device 28 comprises the memory unit 29 which stores the spectra of various screw types associated with their switch-off criteria. The suitable screw types differ in terms of the embossing on their underside 21, especially in terms of the number of ribs 35. The coding by means of the embossing can also indicate the presence of a soft washer 23 or other special features. A suitable switch-off criterion is determined experimentally for each of the screw types. The memory unit 29 can have memory cells that can be written once or multiple times. An appropriate hard-wired or wireless communication interface 47 can be provided on or in the screwdriver 10.

The screw-recognition device 28 uses a search device 48 to search in the stored spectra for a spectrum that matches the one ascertained on the basis of the signal 44. The criteria for the comparison can be the absolute frequencies at which the spectrum has a maximum. The frequency is preferably normalized to the rotational speed of the driven shaft 16. For this purpose, an rpm monitor 49 ascertains the rotational speed of the driven shaft 16 and/or of the motor 11. In the example shown in FIG. 5, the rotational speed is 1 Hz and the significant amplitudes occur at 4 Hz and 8 Hz, which are normalized to the rotational speed at 4 and 8. A threshold value S for the amplitude 43′ can be used to suppress noise components from being impinged onto the spectrum. The threshold value S can be specified, for example, dynamically based on the absolute maximum of the spectrum, e.g. at 10% or 20% of the absolute maximum.

The switch-off criterion associated with the selected spectrum is ascertained in order to set the switch-off criterion of the switch-off device 24. The switch-off criterion can be, for instance, a maximally permissible torque, a maximally permissible rate of increase of the torque, a triggering torque for a clutch, a placement depth for a depth stop.

The switch-off device 24 can be electrically coupled to one or more monitoring sensors in order to monitor their signals in terms of one or more switch-off criteria.

A monitoring sensor 50 detects, for instance, the power consumption of the motor 11. The power consumption of the motor 11 typically rises when the torque that acts upon the spindle 14 increases. The switch-off device 24 can compare, for example, the momentary power consumption to a threshold value that is set as the switch-off criterion. As an alternative or in addition thereto, the power consumption is monitored with respect to a characteristic curve.

Another monitoring sensor 51, for instance, as a strain sensor, can directly detect the torque acting upon the spindle 14. The evaluation and monitoring of its signals are done analogously to the monitoring sensor 50.

Another monitoring sensor 52 is based on a mechanical depth stop 42. The depth stop 42 has a stop 53 that protrudes beyond the tool-receiving socket 17 along the axis of rotation 15 by a certain distance. The stop 53 is mounted along the axis of rotation 15 so as to slide. The depth stop 42 can be configured, for example, in the form of the sleeve 41 that is arranged coaxially with respect to the axis of rotation 15. The monitoring sensor 52 ascertains a distance by which the depth stop 42 is moved during the screwing procedure. The monitoring sensor 52 can comprise, for example, a potentiometer. The switch-off device 24 monitors the ascertained distance and compares it to a maximum distance prescribed by a switch-off criterion. Another monitoring sensor 52 is based on an incremental position measurement. A magnetic tape, for instance, can be arranged on the mechanical depth stop 42. The switch-off device 24 adds up the increments.

Another monitoring sensor 55 is based on a contactless depth stop having a contactless distance meter 56. The distance meter 56 can measure the distance to the surface of the workpiece 20 either optically, acoustically or else by employing radar technology. The switch-off device 24 switches off the rotational movement as soon as the distance of the screw 10 to the workpiece 20 falls below a threshold value set on the basis of a switch-off criterion.

The magnetic-field generator 39 of the active magnetic-field sensor 38 can be a permanent magnet. Preferably, it is an electromagnet 39. The electromagnet 39 is powered by a current source 57. The current source 57 is preferably activated when the button 13 is actuated, and it switches off when the screw type had been ascertained or when the motor 11 has stopped. In this process, any steel shavings that may have formed fall off of the electromagnet 39 before a new screw 19 is fed in by the user or from a cartridge.

The current source 57 can supply a direct current. In an alternative variant, a periodical signal is impinged upon the supply current of the electromagnet 39 by means of an oscillator 59. The signal 44 generated by the magnetic-field sensor 38 is likewise mixed phase-locked with the periodical signal 58, and the harmonics of the periodical signal 50 are filtered out. The signal preparation known as lock-in amplification can be employed to improve the signal-to-noise ratio.

The active magnetic-field sensor 38 can have several inductive sensor elements 40 that are arranged around the axis of rotation 15 in a ring shape. The signals 44 are added up by a summing unit 60. Delay elements 61 are interconnected between the sensor elements 40 and the summing unit 60. The delay elements 61 delay the signals 44 as a function of a relative angle, measured opposite to the direction of rotation of the spindle 14, of the inductive sensor elements 40 with respect to one of the last sensor elements 40 and, optionally, as a function of the rotational speed of the spindle 14. The modulation by a rib 35 is detected at different points in time by the two sensor elements 40. The time difference is compensated for by the delay element 61 so that the signals are structurally superimposed in the summing unit 60. The delay elements 61 can be set as a function of the rotational speed of the spindle 14 and optionally of the direction of the rotation of the spindle 14.

The identification of the screws 19 on the basis of a characteristic modulation of a magnetic field by means of the rotating impressions 35 of the screw 19 has proven to be particularly reliable if the identification takes place as described on the basis of the frequency spectrum of the modulation.

As an alternative, the modulation can also be evaluated directly on the basis of the signal 44 recorded over the course of time. For instance, a trigger module 62 always reports an event when the signal 44 exceeds a threshold value. A counter ascertains the number of events for a given number of revolutions of the screw 19. The number of events for a screw type is correspondingly stored in the memory unit 29. In another alternative embodiment, a buffer records the events for one revolution. The appertaining patterns of events over the course of time relating to the screw types are stored together with the switch-off criteria for the screw type in question.

What is claimed is:

1. A screwdriver comprising:
a motor;
a spindle coupled to the motor in order to turn a screw around an axis of rotation;
an adjustable switch-off device serving to switch off a rotational movement of the spindle;
an active magnetic-field sensor arranged in such away that a modulation, caused by the turning screw, of a magnetic field generated by the active magnetic-field sensor is detectable by the magnetic-field sensor;
a screw-recognition device installed between the active magnetic-field sensor and the adjustable switch-off device in order to set a switch-off criterion for the switch-off device based on the modulation detected by the active magnetic-field sensor.

2. The screwdriver as recited in claim 1 wherein a sensor element of the active magnetic-field sensor sensitive to magnetic fields is arranged in such a manner that the sensor element overlaps with a head of the screw in a direction of the axis of rotation.

3. The screwdriver as recited in claim 1 wherein the active magnetic-field sensor has an electromagnet arranged on a tool end of the spindle.

4. The screwdriver as recited in claim 1 wherein the switch-off device is electrically coupled to the motor in order to switch off the motor.

5. The screwdriver as recited in claim 1 further comprising an electrically actuatable clutch installed in a force path between the motor and the spindle, and the switch-off device is electrically connected to the clutch in order to operate the clutch.

6. The screwdriver as recited in claim 1 further comprising a monitoring sensor for detecting a signal, the signal being a function of a measure for a distance of the spindle to a workpiece or a measure for a torque transmitted to the spindle, the switch-off device being coupled to the monitoring sensor in order to compare the signal to a switch-off criterion.

7. The screwdriver as recited further comprising a screw-recognition device has a frequency analyzer to determine a spectrum of the modulation.

8. The screwdriver as recited in claim 7 wherein the screw-recognition device has a memory unit storing parameterized modulations as well as stored switch-off criteria associated with the parameterized modulations, the screw-recognition device having a search device to select switch-off criteria associated with a particular parameterized modulation and corresponding to the modulation detected by the active magnetic-field sensor.

9. The screwdriver as recited in claim 1 wherein the active magnetic-field sensor has several inductive sensor elements arranged around the axis of rotation in a ring shape, and, in each case, a delay element is connected downstream from sensor elements of the magnetic-field sensor for purposes of delaying a signal transmission time.

10. A control method for a screw comprising the following steps:
driving a spindle by a motor in order to turn a screw around an axis of rotation;
generating a magnetic field in a vicinity of the turning screw;
detecting a modulation of the magnetic field caused by the turning screw by an active magnetic-field sensor;
selecting switch-off criterion by a screw-recognition device on the basis of the detected modulation; and
stopping the turning of the screw by a switch-off device as soon as the switch-off criterion is met.

11. The control method as recited in claim 10 wherein the stopping includes deactivating the motor by the switch-off device.

12. The control method as recited in claim 10 wherein the stopping includes the switch-off device transmitting a control signal to release a clutch located between the motor and the spindle.

13. The control method as recited in claim 10 wherein a frequency spectrum of the modulation is ascertained and the switch-off criterion is selected on the basis of the frequency spectrum.

14. The control method as recited in claim 10 wherein a monitoring sensor detects a signal serving as a measure for the distance of the spindle to a workpiece and/or a further signal as a further measure for a torque transmitted to the spindle, the switch-off device comparing the detected signal to the switch-off criterion.

15. The control method as recited in claim 10 wherein the selection of the switch-off criterion entails the selection of the switch-off criterion from a memory unit, a search device selecting the switch-off criterion whose parameterized modulation stored in the memory unit corresponds to the modulation detected by the active magnetic-field sensor.
